(19) United States
(12) Patent Application Publication
(10) Pub. No.: US 2026/0237264 A1
(43) Pub. Date: Aug. 13, 2026

(54) SENSOR-BASED AUTHORIZATION AT A PHYSICAL PREMISES

(71) Applicant: The Toronto-Dominion Bank, Toronto (CA)

(72) Inventors: Pooja CHUGH, Mississauga (CA); Niharika TUGNAIT, Toronto (CA); Disha KUNDRA, Toronto (CA)

(73) Assignee: The Toronto-Dominion Bank, Toronto (CA)

(21) Appl. No.: 19/050,622

(22) Filed: Feb. 11, 2025

(51) Int. Cl. G07C 9/20

(52) U.S. Cl. CPC G07C 9/20

(57) ABSTRACT

A processor-implemented method and system are described. The method may include: using a sensor positioned at a physical premises to scan a machine-readable code; obtaining a session identifier from the machine-readable code; and using the session identifier to: determine that an entity has been authenticated; and initiate a pre-authorization. One or more operations of the method may be automated.

### FIELD

The present disclosure relates to sensor-based authorization and, more particularly, to systems and computer-implemented methods for using a sensor positioned at a physical premises for an authorization.

### BACKGROUND

Sensors are sometimes deployed at a physical premises such as a building to allow for authentication and authorization. Often, a user will tap a card at a reader when they enter a building and a computer system monitors the user's movements and activities in the building. Once authenticated, the user may need to provide credentials to the computer system for an authorization while at the physical premises.

It would be advantageous to provide for improved computer-implemented authentication and authorization techniques that minimize or reduce human-machine interactions and the number, variety, or complexity of sensors needed at the physical premises.

### BRIEF DESCRIPTION OF THE DRAWINGS

Reference will now be made, by way of example, to the accompanying drawings which show example embodiments of the present application, and in which:

FIG. 1 shows an elevation view of a physical premises;

FIG. 2 shows a schematic diagram illustrating an operating environment of an example embodiment according to the subject matter of the present application;

FIG. 3A shows a high-level schematic diagram of the client device, first computing system and second computing system of FIG. 2;

FIG. 3B shows a simplified organization of software modules stored in a memory of the example computing systems of FIG. 3A;

FIG. 4 is a flowchart showing operations performed in displaying a machine-readable code, according to an example embodiment;

FIG. 5 is a flowchart showing operations performed in initiating a pre-authorization based on sensor input, according to another example embodiment;

FIG. 6 is a flowchart showing operations performed in processing a further pre-authorization, according to another example embodiment;

FIG. 7 is an example graphical input interface for initiating a session, according to an example embodiment; and

FIG. 8 is an example graphical input interface for selecting an entity;

FIG. 9 is an example graphical interface for displaying a machine-readable code;

FIG. 10 is an example graphical interface for displaying a success notification;

FIG. 11 is an example graphical interface for providing consent to a further pre-authorization of a transfer; and

FIG. 12 is an example graphical interface for automatically processing a further pre-authorization of a transfer.

Similar reference numerals may have been used in different figures to denote similar components.

### DETAILED DESCRIPTION OF EXAMPLE EMBODIMENTS

In one aspect, the present application describes a system. The system may include a sensor positioned at a physical premises, a communications module; one or more processors coupled to the sensor and the communications module; and a memory coupled to the one or more processors. The memory may store instructions that, when executed, cause the one or more processors to use the sensor to scan a machine-readable code; obtain a session identifier from the machine-readable code; and use the session identifier to: determine that an entity has been authenticated; and initiate a pre-authorization.

In some implementations, the pre-authorization may be for a defined amount.

In some implementations, the pre-authorization may be initiated without a transfer credential.

In some implementations, the instructions may further cause the one or more processors to monitor contents of a receptacle; determine that the pre-authorization is insufficient based on the contents of the receptacle; and in response to a determination that the pre-authorization is insufficient, take an action.

In some implementations, the action may include outputting on the receptacle a notification indicating that a further pre-authorization is to be processed if a defined condition is undetected during a time period.

In some implementations, the instructions may further cause the one or more processors to detect an elapse of the time period prior to a detection of the defined condition and, in response, process the further pre-authorization.

In some implementations, the action may include inhibiting movement of the receptacle.

In some implementations, the instructions may further cause the one or more processors to determine that a further pre-authorization is processed following the action inhibiting the movement of the receptacle and, in response, remove the action inhibiting the movement of the receptacle.

In some implementations, the pre-authorization is processed using the session identifier without requiring a data transfer credential.

In some implementations, the pre-authorization is processed using the session identifier without a payment credential.

In some implementations, a further automated pre-authorization is processed using the session identifier without a payment credential.

In yet another aspect, the present application describes a computer-implemented method. The computer-implemented method may include using a sensor positioned at a physical premises to scan a machine-readable code; obtaining a session identifier from the machine-readable code; and using the session identifier to: determine that an entity has been authenticated; and initiate a pre-authorization.

In some implementations, the method may further include monitoring contents of a receptacle; determining that the pre-authorization is insufficient based on the contents of the receptacle; and in response to determining that the pre-authorization is insufficient, taking an action.

In some implementations, the method may further include detecting an elapse of the time period prior to a detection of the defined condition and, in response, processing the further pre-authorization.

In some implementations, the method may further include determining that a further pre-authorization is processed following the action inhibiting the movement of the receptacle and, in response, removing the action inhibiting the movement of the receptacle.

In yet another aspect, present application describes a non-transitory computer-readable storage medium comprising processor-executable instructions which, when executed, may configure one or more processors to use a sensor positioned at a physical premises to scan a machine-readable code; obtain a session identifier from the machine-readable code; and use the session identifier to: determine that an entity has been authenticated; and initiate a pre-authorization.

In yet a further aspect, the present application describes a non-transitory computer-readable storage medium storing processor-readable instructions that, when executed, configure one or more processors to perform any of the methods described herein. Also described in the present application is a computing device comprising: one or more processors, memory, and an application containing processor-executable instructions that, when executed, cause the one or more processors to carry out at least one of the methods described herein. In this respect, the term processor is intended to include all types of processing circuits or chips capable of executing program instructions.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, reference may be made to the terms “automatic”, “automatically” or automated. These terms may cover an action or operation that does not require outside (human or machine) intervention in order to be triggered, performed, and/or completed. In some embodiments, these terms may cover an action or operation that may be triggered, performed, and/or completed without manual input via, for example, a manual input device.

In the present application, reference may be made to the term “real-time”. In at least some embodiments, real-time is defined as being within seconds. Certain factors, such as network traffic, may limit the immediacy of real-time transfers and/or processing of resource demands.

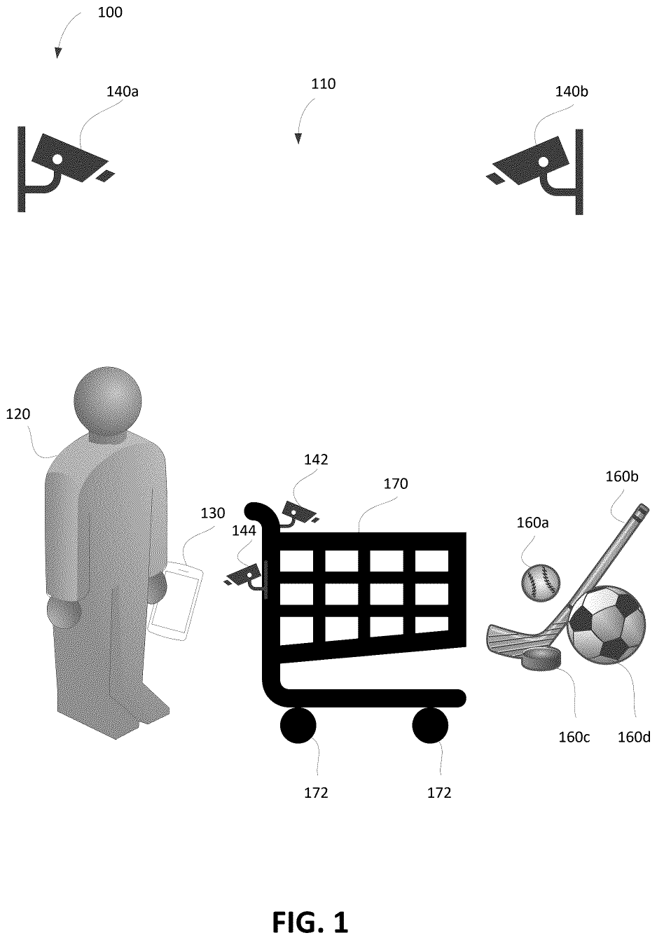

FIG. 1 is an elevation view of a sensor system 100 at a physical premises 110. The physical premises 110 may be a merchant location such as a store. The store may be a bricks-and-mortar establishment at which a customer may physically attend to shop. By way of example, the store may be or include any one or more of a grocery store, a department store, a clothing store, a thrift shop, a sporting goods store, a big box store, a pet store, a discount store, a warehouse store, a convenience store, or a store of another type. In some embodiments, the sensor system 100 may be an ambient commerce system and may be referred to as a cashier-less checkout system, an ambient checkout system, a “just-walk-out” system or “grab and go” system.

The sensor system 100 includes one or more sensors which are used by the sensor system 100 to identify one or more items 160a-d that are sold at the physical premises 110 and that are being purchased by an entity 120 such as a customer who is on site at the physical premises 110. The items may be or include any products. By way of example, the items 160a-d that are available for purchase via the sensor system 100 may be or include groceries, electronic goods, sporting goods, accessories, clothing, or goods of another type.

The sensor system 100 may include various sensors. One or more of the sensors may be on site at the physical premises 110. The sensors may generate respective sensor outputs that may be used by the sensor system 100 to facilitate ambient commerce. For example, the sensors may be or include one or more cameras 140a, 140b. The cameras may be located at various regions throughout the physical premises 110. In some implementations, the cameras 140a, 140b are part of a camera array or camera grid. The camera array or grid may provide complete or near complete coverage of all areas of the sensor system 100 and the cameras may be configured to provide some overlap in camera coverage. In some implementations, each of the cameras may include multiple image sensors or the cameras may be configured in multiples such as pairs to enable the sensor system 100 to determine and evaluate depth information as part of its analysis.

The sensors may include a receptacle contents detector 142. The receptacle contents detector 142 may be provided on or associated with a particular receptacle 170. The particular receptacle 170 is a container or other receptacle which may be used for holding or transporting goods while shopping. The particular shopping receptacle may, for example, be a shopping cart, shopping basket, shopping bag, or shopping bin.

The receptacle contents detector 142 may be or include any one or more of: a camera, a barcode reader, a quick response (QR) code reader, a wireless tag reader such as a radio frequency identifier (RFID) reader or a sensor of another type.

In some implementations, one or more of the items 160a, 160b, 160c, 160d that may be available for purchase may include a physical feature which facilitates identification of that item by one of the sensors. By way of example, the items may include a barcode which may be scanned by a barcode reader or camera, a QR code which may be scanned by a QR code reader or scanner, and/or a wireless tag such as an RFID tag.

The sensors included in the sensor system 100 may be or include a receptacle contents detector 142. The receptacle contents detector 142 may be or include one or more cameras. The receptacle contents detector 142 may be used to identify an item added to or removed from the cart. The sensor system 100 may be configured to detect items 160a, 160b, 160c, 160d that are being purchased using any one of a number of techniques. The sensor system 100 may determine, using the receptacle contents detector 142, whether the contents of the receptacle 170 exceed a pre-authorization amount. If so, the system may take a variety of actions. For example, the system may process a further pre-authorization.

The sensors included in the sensor system 100 may include other types of sensors and readers including, for example, a session identifier sensor. The sensors may exclude a physical card reader such as a payment card reader. A payment card reader may be or include a credit card reader or debit card reader.

The sensors included in the sensor system 100 may be or include a fixture of the premises. A fixture may be an integral component of the premises and may be physically and permanently attached or fastened to the premises. A fixture may also be immovable, stationary, and mounted at a fixed location relative to the premises. By way of example, the cameras 140a, 140b may be fixtures that are mounted on a wall of the premises.

In some embodiments, the sensors included in the sensor system 100 may be or include a sensor that is not a fixture and is instead attached to or part of chattel. The term chattel may refer to an item that is not an integral component of the premises and/or may not be physically and permanently attached or fastened to the premises. The sensor may be an integral component of the chattel and/or physically and permanently attached or fastened to the chattel, without being fixed to the premises. The chattel and sensor may be movable relative to the premises. By way of example, the receptacle contents detector 142 may be mounted on a movable receptacle 170.

In at least one implementation, the sensor system 100 is in communication with one or more other systems which may be used to assist with authentication of an entity. By way of example, the sensor system 100 may be in communication with a trusted system. The trusted system may be a resource server. For example, the trusted system may be a financial institution system. The trusted system may be an independent third-party system that is separately operated and controlled from the sensor system.

The trusted system may provide, to the sensor system 100, an indication that authentication has been performed by the trusted system for an entity that is unauthenticated by the sensor system 100. The indication may indicate that identity of a customer has been verified by the trusted system. Such verification may be performed based on a biometric, such as a fingerprint, voiceprint or faceprint, or it may be performed based on input of a credential, such as a personal identification number (PIN) or password. The verification may be performed via an interaction between the trusted system and the electronic device 130, which may be operated by the customer.

The indication may indicate an identity of the entity. For example, the indication may indicate the identity of the customer using an identifier associated with the entity 120. The identifier may be or include a name. In at least some implementations, the identifier may be or include a unique identifier such as a unique account identifier. By way of example, the indication may include an account number.

Accordingly, in some implementations, identity may be detected, determined, or verified, in whole or in part, by the sensor system 100 without receiving verification data, for example biometric data and/or a credential, used by the trusted system to verify the identity of the entity 120.

The sensor system 100 and/or a trusted system may include or operate in cooperation with an electronic device 130 associated with an entity 120. The electronic device 130 may be a portable electronic device such as a smartphone, smartwatch or other wearable electronic device. The electronic device 130 may, in some implementations connect with the sensor system 100 and/or the trusted system when it is within a geolocation or geofence associated with the sensor system 100. For example, when the electronic device 130 is at the physical premises 110, it may connect with the sensor system 100 and/or the trusted system. Such communication may be performed via a long or short range communication protocol. In some implementations, the electronic device 130 may have an ambient commerce application and/or sensor application stored thereon which is configured to enable the electronic device 130 to communicate with the sensor system 100. In some implementations, the electronic device 130 may have a trusted system application stored thereon such as, for example, a banking application, which is configured to enable the electronic device 130 to communicate with the trusted system.

The electronic device 130 associated with an entity 120 may be used for other purposes instead of or in addition to identification and customer detection. For example, the electronic device 130 may include an output interface such as a display screen or speaker and the output interface may be used for outputting notifications generated by the sensor system 100, the trusted system, or by another system associated with the sensor system 100.

In some implementations, the sensor system 100 may perform a computer operation in response to determining that the value of the contents of the receptacle exceeds a pre-authorization amount. The receptacle may inform the customer that they have exceeded the pre-authorization amount and may request consent for a further pre-authorization amount. This notification may be displayed on a display associated with the receptacle. The notification may, for example, request input to confirm that a further pre-authorization may be processed. In one example, the request input to confirm that a further pre-authorization may be processed. In one example, the notification may indicate that, if an item is not removed from the receptacle within a period of time, a further pre-authorization may be processed. In one example, the notification may indicate that, if an item is not removed from the receptacle within a period of time, a further pre-authorization will be automatically processed. For example, the notification may indicate that a further preauthorization may be processed if an time is not removed within thirty seconds. If an item is not removed within the time period, then the sensor system 100 may process the further preauthorization.

In some embodiments, the receptacle 170 may be movement restricted when the initial pre-authorization amount is exceeded until a further pre-authorization is processed. For example, the receptacle may include wheels 172 that may be automatically locked to prevent movement, or one or more wheels 172 may be inhibited to slow movement, or a lockable gate (not shown) may be controlled to prevent the shopping cart from leaving an area or premises.

In some implementations, the sensor system 100 may control an electrically controlled exit prevention device such as an electrically controlled gate associated with an exit for the premises as a direct result of the determination that a pre-authorization amount is exceeded. The electrically controlled gate may be, for example, an electrically controlled turnstile.

In some implementations, the sensor system 100 may control one or more wheels 172 including as a direct result of the determination that a pre-authorization amount is exceeded. An electrically controlled wheel may include an electronic braking control and/or electronically controlled brake. The electronic braking control may activate a wheel brake to lock or prevent movement, or inhibit to slow movement, a wheel 172 of the receptacle 170.

In at least some implementations, the electronic device 130 may be used to identify an entity 120. For example, the electronic device 130 may share a machine-readable code with the sensor system 100. The sensor system 100 may determine that a particular entity 120 is on site at the physical premises 110 when the machine-readable code is detected by the sensor system 100.

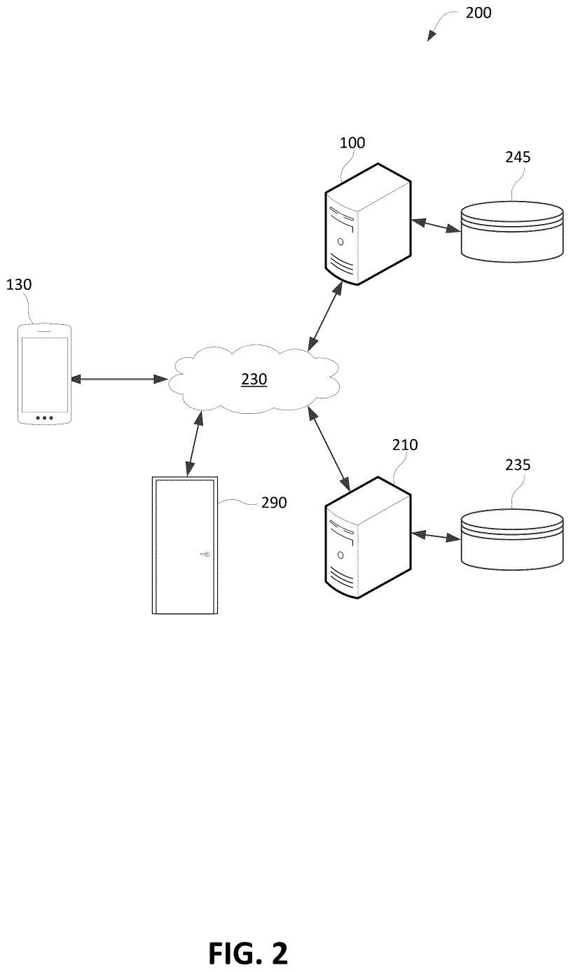

FIG. 2 is a schematic operation diagram illustrating an operating environment of an example embodiment. FIG. 2 illustrates a system 200 which may be or include a sensor system 100. The sensor system 100 may be of the type described above with reference to FIG. 1, or a variation thereof. The sensor system 100 may be or include a computer system. The computer system may be coupled with one or more sensors, as described with reference to FIG. 1 and may receive sensor output from such sensors.

The operating environment in this example includes an electronic device 130, sensor system 100, and a independent trusted systems 210. In some embodiments, the operating environment may include one or more electronic devices or a plurality of electronic devices, which may include the electronic device 130.

The electronic device 130 may be as described above with reference to FIG. 1. For example, the electronic device 130 may be associated with an entity, such as a customer. The electronic device 130 may also be a computer system.

The electronic device 130 may be in communication with the sensor system 100. Such communication may be via a direct connection or it may be an indirect connection. An indirect connection may be a connection that relies upon other intermediary computers or systems to relay messages. For example, as illustrated in FIG. 2, the sensor system 100 and the electronic device 130 may be coupled to and communicate with one another via a network 230. The network 230 may be of various types. The network 230 may be a computer network. In some embodiments, the computer network may be an internetwork and may be formed of one or more interconnected computer networks. For example, the computer network may be or may include an Ethernet network, an asynchronous transfer mode (ATM) network, a wireless network, a telecommunications network or the like.

In some implementations, at least some communications between the electronic device 130 and the sensor system 100 may occur over a direct connection. A direct connection may be a local communication method which may not require a network. For example, example direct connections include NFC, WiFi, and Bluetooth.

The system 200 may be or include one or more trusted systems 210. The trusted system may be a resource server, for example. A resource server may track, manage, and maintain resources, adjudicate lending requests, and/or lend resources for a plurality of entities. For example, resources available for a plurality of entities may be specified in account data for such entities. The resources may, for example, include computing resources, such as memory or processor cycles. By way of further example, the resources may include stored value, such as fiat currency, which may be represented in one or more databases. For example, as shown in FIG. 2, the trusted systems 210 may be coupled to a database 235, which may be provided in secure storage. The secure storage may be provided internally within the trusted systems 210 or externally; the secure storage may, for example, be provided remotely from the trusted systems 210. In some embodiments, the secure storage may include one or more data centers. The data centers may, for example, store data with bank-grade security.

The trusted systems 210 may include a resource request processing engine (not shown in FIG. 1) . A resource request processing engine may be implemented to automatically process resource transfer requests that are received at an trusted system 210. Specifically, the resource request processing engine may be configured to process requests to transfer resources that are associated with one or more resource accounts managed by the trusted systems 210. The resource request processing engine may process resource transfer requests in accordance with defined handling actions. For example, the resource request processing engine may be configured to automatically process resource transfer requests without manual intervention by related entities for the resource transfer requests. The trusted systems 210 may include a sensor interface engine that may be configured to interface with a sensor system.

The database 235 includes account data for a plurality of accounts associated with a plurality of entities. For example, the database 235 may include records for a plurality of accounts and at least some of the records may define a quantity of resources associated with an entity. For example, the entity that is associated with the electronic device 130 (which may also be referred to as a client device or customer device) may be associated with a resource account having one or more records in the database 235. The data records may reflect a quantity of stored resources that are associated with the entity. Such resources may include owned resources and, in at least some embodiments, borrowed resources (e.g., resources available on credit). The quantity of resources that are available to or associated with an entity may be reflected by a balance defined in an associated record such as, for example, a bank balance. In some implementations, a record for an account may be or include a resource parameter or enable the determination of a resource parameter. A resource parameter may, for example, indicate whether a particular entity associated with an account has access to a resource. In some implementations, the resource parameter may specify whether the particular entity associated with the account has access to a borrowed resource. In some implementations, the resource parameter may indicate a resource balance. The balance may be a balance associated with owned or borrowed resources.

The database 235 may also include identity verification data for entities having accounts in the database 235. The identity verification data may be or include a shared secret and/or biometric data such as a fingerprint, voiceprint and/or facial profile data. In some implementations, the identity verification data may be or include a transaction listing or other historical information such as, for example, behavioural data. In at least some implementations, the trusted systems 210 may share at least some of the identity verification data with the sensor system 100 to assist with verifying identity of an entity at an physical premises 110. In other implementations, rather than share the identity verification data itself, the trusted systems 210 may, instead, perform identity verification for the sensor system and may confirm to the sensor system the identity of an entity.

The database 235 may also include profiles for a plurality of entities. A profile may also be referred to as profile data and such data may be part of the account data, for example. A profile may be or include biographical data associated with an entity. By way of example, the profile may be or include an age identifier for the entity, such as an age or date of birth. By way of further example, the profile may be or include other information about the entity such as residential information (including, for example, a city of residence, country of residence, etc.), income information (such as an annual income), past spending or shopping information, or information about products associated with the entity (such as whether the entity has a particular credit card or information about whether the entity is a subscriber to a particular service, or information about whether is a member of a particular loyalty program).

The trusted systems 210 may, for example, be a financial institution system and the entity associated with an electronic device 130 may be a customer of a financial institution operating the financial institution system.

The trusted systems 210 may be or include a computer system. The trusted systems 210 may be in communication with the sensor system 100. In the illustrated example, the trusted systems 210 is in communication with the sensor system 100 via the network 230. The trusted systems 210 may also communicate with one or more electronic devices 130 via the network 230.

As illustrated in FIG. 2, the sensor system 100 may also include or be connected to a datastore 245 such as a database. The datastore 245 may be or include an inventory tracking data store. In some implementations, the datastore 245 may include product data for one or more items that are physically present in the physical premises 110. By way of example, the datastore 245 may include one or more parameters associated with items available at the physical premises 110. Such parameters may be referred to as item parameters. Example item parameters may be or include a value parameter and/or a class parameter. A value parameter may be an indicator of a cost or price of an item. Put differently, the value parameter for an item may represent an amount of resources required to transfer ownership of the item to an entity. The value parameter may, in some implementations, be expressed in units of currency, such as in dollars, Euros, Francs, etc.

A class parameter may define a category or classification that an item belongs to and it may also be referred to as a category parameter. The category may represent a type of the item. By way of example, example categories may include any one or a combination of: consumer electronics, televisions, sporting goods, bicycles, financeable products, clothing, grocery items, etc.

In some instances, a particular item may be associated with multiple class parameters. By way of example, an item may be associated with a broad class parameter that defines a broad category of the item (e.g., consumer electronic) and a narrow class parameter that defines a narrow category of the item (e.g., television). In some implementations, the class parameter(s) for an item may be or include a binary class parameter. A binary class parameter is a class parameter that operates as a flag which defines whether the item is or is not a particular type of good associated with that class parameter. By way of example, a binary class parameter may indicate whether an item is financeable. In some implementations, a financeable item may be an item that is available for purchase using a buy now pay later feature.

The class parameter(s) for an item may also be or include a brand parameter. A brand parameter indicates a brand associated with the item. The brand may be a manufacturer of the item. The brand may be a brand that is reflected on packaging associated with the item.

The datastore 245 or another datastore may also include item identification data. The item identification data may be data that is used by the sensor system to identify an item in the physical premises 110. By way of example, in a system that relies upon a code such as a barcode or QR code for identification of items, the item identification data may include a representation of the code for a particular item. By way of further example, in a system which relies upon packaging identification, the item identification data may include information about the packaging of an item. By way of further example, in a system that relies upon in-store placement information to identify items, the item identification data may include information defining a location within the physical premises 110 at which a particular item is located. By way of example, the in-store placement information may specify an aisle number, region number, shelf number, etc. and such numbers (or other identifiers) may be known to the sensor system so that the sensor system is able to identify the particular items available at various regions of the physical premises 110.

By way of further example, in a system which relies upon a tag such as an RFID tag, the item identification data may specify a number or other identifier associated with the tag.

The sensor system 100 may also include or be connected to an electronic device 280 associated with an in-store operator. The in-store operator may be an employee of a merchant operating the physical premises 110, for example. The electronic device 280 associated with the in-store operator may be of a type that is the same or similar to the electronic device 130 associated with the entity. By way of example, the electronic device 280 may be a laptop or desktop computer, a mobile computing device such as a smartphone, a smart watch or other wearable or an electronic device of another type. The electronic device 280 associated with the in-store operator may communicate with the sensor system 100 by way of a network 230.

The sensor system 100 may also include or be connected to an electrically controlled exit prevention device 290 such as an electrically controlled gate or door associated with an exit for the physical premises 110. The electrically controlled exit prevention device 290 may be controlled to prevent the entity from leaving the physical premises 110 with a restricted item when the entity has not demonstrated eligibility to purchase the age-restricted item. In some implementations, the electrically controlled exit prevention device 290 may be or include an electrically controlled lock. In some implementations, the electrically controlled exit prevention device 290 may be or include an automatic door which may be controlled to disable opening of the door to prevent exit by an entity.

While a single trusted system 210 is illustrated in FIG. 2, in some implementations there may be multiple trusted systems 210. These trusted systems 210 may be independent of one another. For example, they may be operated by different entities. Each may be in communication with the sensor system 100.

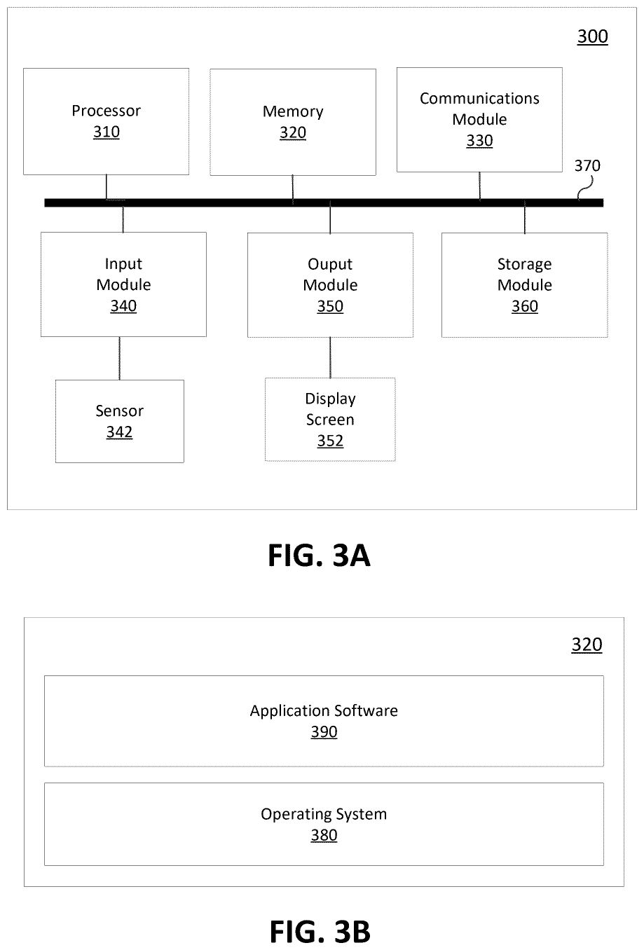

FIG. 3A is a high-level schematic diagram of an example computing device 300. In some embodiments, the example computing device 300 may be exemplary of the sensor system 100, electronic device 130, or one or more trusted systems 210 in the example system 200 of FIG. 2.

The example computing device 300 includes a variety of modules. A module may include one or more modules and may be a subsystem and/or include an interface. In some cases, a module is a hardware module and may be integrated into or include an electronic circuit.

As illustrated, the example computing device 300 may include a processor 310, a memory 320, a communications module 330, an input module 340, a sensor 342, an output module 350, display screen 352, and/or a storage module 360. As illustrated, the foregoing example modules of the example computing device 300 are in communication over a bus 370.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 300.

The communications module 330 allows the example computing device 300 to communicate with other computing devices and/or various communications networks. For example, the communications module 330 may allow the example computing device 300 to send or receive communications signals. Communications signals may be sent or received according to one or more protocols or according to one or more standards. For example, the communications module 330 may allow the example computing device 300 to communicate via one or more wireless networks, such as for example, a cellular wireless network, according to one or more standards such as, for example, Global System for Mobile Communications (GSM), Code Division Multiple Access (CDMA), Evolution Data Optimized (EVDO), Long-term Evolution (LTE), or 5G. Additionally or alternatively, the communications module 330 may allow the example computing device 300 to communicate via a wireless personal area network (WPAN) via some combination of one or more networks or protocols such as, for example, Bluetooth™ and Zigbee™. In some embodiments, all or a portion of the communications module 330 may be integrated into a component of the example computing device 300. For example, the communications module 330 may be integrated into a communications chipset or circuit. In some embodiments, the communications module 330 may be or include a network adapter, which may be wired or wireless. For example, the communications module 330 may be integrated into a communications chipset or circuit.

The input module 340 allows the example computing device 300 to receive input signals. Input signals may, for example, correspond to input received from a user. The input module 340 may serve to interconnect the example computing device 300 with one or more input devices. Input signals may be received from input devices by the input module 340. Input devices may, for example, include one or more of a touchscreen input, keyboard, trackball or the like. In some embodiments, all or a portion of the input module 340 may be integrated with an input device. For example, the input module 340 may be integrated with one of the aforementioned examples of input devices.

The input module 340 may receive input from a sensor 342 that may be a sensor that gathers and generates sensor data based on a sensed condition. By way of example, the sensor 342 may be or include a camera subsystem. The sensor 342 may be or include one or more of the cameras 140a, 140b, receptacle contents detector 142, or code scanner 144 of the sensor system 100 of FIG. 1.

The camera subsystem may be configured to generate camera data, such as images in the form of still photographs and/or video data. The camera data may be captured in the form of an electronic signal that is produced by an image sensor included in or associated with the camera subsystem. More particularly, the image sensor may be configured to produce an electronic signal in dependence on received light. The image sensor may convert an optical image into an electronic signal, which may be output from the image sensor by way of one or more electrical connectors associated with the image sensor. The electronic signal represents electronic image data, which may be referred to as camera data or sensor data.

The output module 350 allows the example computing device 300 to provide output signals. Some output signals may, for example allow provision of output to a user. The output module 350 may serve to interconnect the example computing device 300 with one or more output devices. Output signals may be sent to output devices by output module 350. Output devices may include, for example, a display screen 352 such as, for example, a liquid crystal display (LCD), or a touchscreen display. The display screen 352 may present graphics and display graphical user interfaces. Additionally, or alternatively, output devices may include devices other than screens such as, for example, a speaker, indicator lamps (such as, for example, light-emitting diodes (LEDs)), and printers. In some embodiments, all or a portion of the output module 350 may be integrated with an output device. For example, the output module 350 may be integrated with one of the aforementioned example output devices.

The storage module 360 allows the example computing device 300 to store and retrieve data and, in some embodiments, may be referred to as a data store or data facility. In some embodiments, the storage module 360 may be formed as a part of the memory 320 and/or may be used to access all or a portion of the memory 320. Additionally or alternatively, the storage module 360 may be used to store and retrieve data from persisted storage other than the persisted storage (if any) accessible via the memory 320. In some embodiments, the storage module 360 may be used to store and retrieve data in/from a database. A database may be stored in persisted storage. Additionally or alternatively, the storage module 360 may access data stored remotely such as, for example, as may be accessed using a local area network (LAN), wide area network (WAN), personal area network (PAN), and/or a storage area network (SAN). In some embodiments, the storage module 360 may access data stored remotely using the communications module 330. In some embodiments, the storage module 360 may be omitted and its function may be performed by the memory 320 and/or by the processor 310 in concert with the communications module 330 such as, for example, if data is stored remotely. The storage module 360 is illustrated as a single unit for ease of illustration, but may include a plurality of storage units.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 3B depicts a simplified organization of software modules stored in the memory 320 of the example computing device 300 of FIG. 3A. As illustrated, these software modules include an operating system 380 and application software 390.

The operating system 380 is software. The operating system 380 allows the application software 390 to access the processor 310, the memory 320, the communications module 330, the input module 340, the sensor 342, the output module 350, the display screen 352, and the storage module 360 of the example computing device 300. The operating system 380 may be, for example, Google™ Android™, Apple™ iOS™, UNIX™, Linux™, Microsoft™ Windows™, Apple OSX™, Linux™ distribution, or the like.

The application software 390 adapts the example computing device 300, in combination with the operating system 380, to operate as a device performing particular functions.

The application software 390 may include an image processing module that may be engaged to convert image data of text into machine-encoded or machine-readable text. The conversion of image data to machine-encoded or machine-readable text may use techniques such as optical character recognition (OCR). In some embodiments, the image processing module may be considered an OCR module and may be included in an OCR application for converting image data of text into machine-encoded or machine-readable text.

The application software 390 may include an application for configuring the computing device 300 to receive application programming interface requests from a computer system. The software module may include or use one or more application programming interfaces (APIs). An application programming interface may perform operations to service the application programming interface requests. The application programming interface requests may define parameters. In some cases, the application programming interface may facilitate communication between software modules and may be capable of transferring data or resources between software modules.

The application software 390 may include an application for configuring the computing device 300 to transmit application programming interface requests or replies to a computer system. The application may include, provide or use an application programming interface (API) to communicate with, offer services to, and/or receive services from, another application, program, or software component. More particularly, the application programming interface be used to connect to and transfer data or resources to and/or from one or more computer systems. The example computing device 300 may store connection data associated with the application programming interface, such as an identifier identifying a computing device or system. In some cases, the identifier may be or include a server identifier, such as, for example, an Internet Protocol (IP) address or domain name. The identifier may be used in conjunction with the application programming interface to establish a connection with the computing system.

The application programming interface may utilize a messaging protocol. The application may generate and/or receive messages in conformance with a messaging protocol or format for invoking the application programming interface. The application programming interface may be capable of and/or configured to perform data transfers in real-time or facilitate a real-time transfer and may utilize a messaging protocol that supports real-time data transfers.

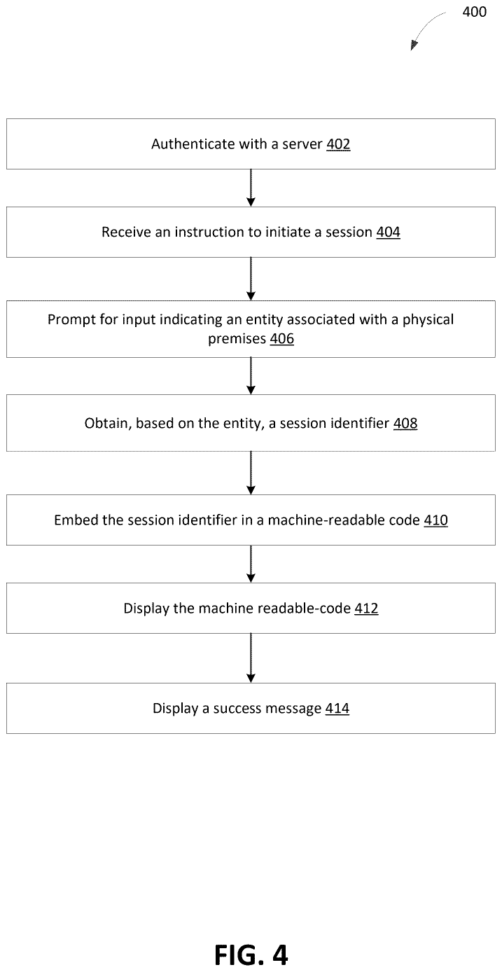

Reference will now be made to FIG. 4 which illustrates an example method 400 of displaying a machine-readable code. The method 400 may be implemented by one or more computer systems suitably programmed to carry out the functions described. In some embodiments, the operations may be performed by the electronic device 130 of FIG. 2, which may cooperate and communicate with a sensor system 100 and/or a trusted system 210 of FIG. 2 to perform the method 400 or a variation thereof.

In operation 402, the computer system authenticates with a server. In some embodiments, the computer system may be the electronic device 130 of FIG. 2 and the server may be a trusted system 210 of FIG. 2. The authentication may include authentication of an entity associated with the computer system. The entity may be an operator of the computer system and/or user of a software application associated with the server. Such authentication may be performed based on one or more authentication techniques. An authentication technique may, for example, be performed using a biometric, such as a fingerprint, voiceprint or faceprint, or it may be performed based on input of a credential, such as a PIN or password. The entity that is authenticated with the server may be referred to as the authenticated entity.

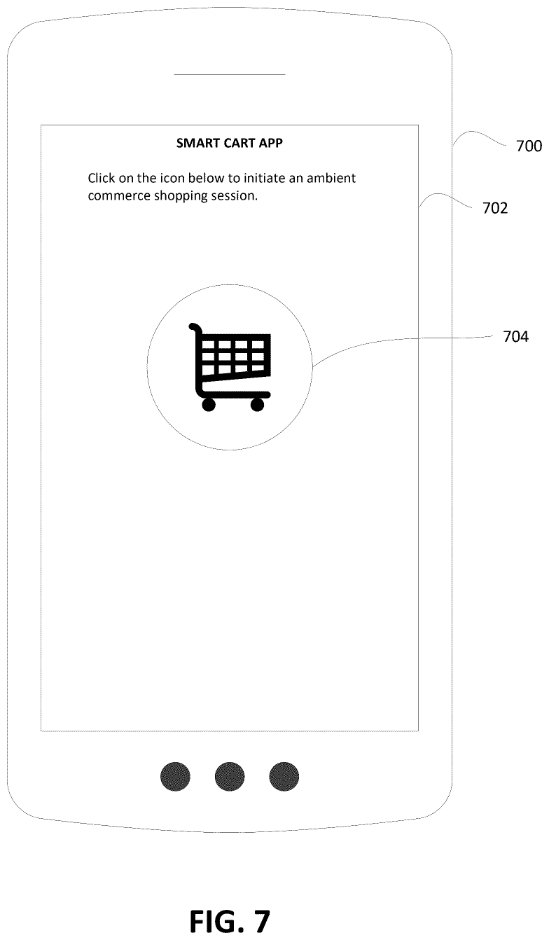

In operation 404, the computer system receives an instruction to initiate a session. The instruction may correspond to or be based on input received at an input interface. For example, referring briefly to FIG. 7, shown is an illustration of the front view of an example electronic device 700 including a session initiation interface 702 for initiating a session. The electronic device 700 may be a smartphone that implements the electronic device 130 of FIG. 1. The session initiation interface 702 may be a display interface and/or graphical input interface of the software application associated with the server. The session initiation interface 702 may prompt the user to initiate a session and may include a selectable interface element 704 that may be activated to trigger input indicating an instruction to initiate the session. In some embodiments, the selectable interface element 704 may be tapped or clicked to actuate the icon and indicate selection of the option to initiate a session. The instruction to initiate the session may correspond to or be triggered by a user clicking or tapping the selectable interface element 704.

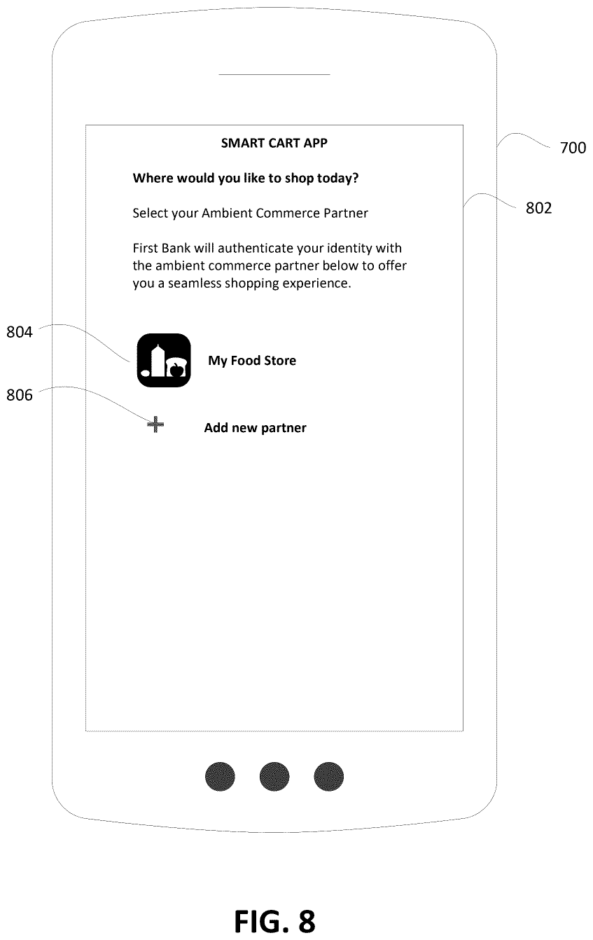

In operation 406, the computer system prompts for input indicating an entity corresponding to or associated with a physical premises. For example, in response to invoking the selectable interface element 704, the session initiation interface 702 may present, as shown in FIG. 8, one or more selectable interface elements for identifying an entity. A selectable interface element may correspond to a physical premises and/or an entity associated with, controlling, and/or operating at a physical premises.

Referring briefly to FIG. 8, shown is an example entity identification interface 802 for identifying entity. The entity identification interface 802 may be displayed at the electronic device 700 upon activation of the selectable interface element 704 of the session initiation interface 702 of FIG. 7. The entity identification interface 802 may provide one or more selectable options or selectable interface elements for selecting one entity from a list of entities. An option may be presented as a link, button or other actionable interface element and may include text. The text may include a name and/or brief description of an entity. The actionable interface element may be activated to submit an indication of an identification of an entity. By way of example, the example entity identification interface 802 includes a first option 804 for identifying an entity named “My Food Store” and corresponding to a physical premises. The first option 804 may be activated to submit an indication of the identification of the entity named “My Food Store”. The indication may include an entity identifier corresponding to the selected option. The example entity identification interface 802 also includes a selectable option 806 for adding one or more entities to the list of entities.

Referring back to FIG. 4, in operation 408, in response to receiving the indication of the identification of an entity, the computer system may obtain a unique session identifier. The computer system may transmit a request to the server to obtain the session identifier. The request may include an entity identifier corresponding to the identification of the selected entity.

In response to receiving the request from the computer system, the server may generate the session identifier. The generation may be based on the entity identifier and the session identifier. The session identifier may be unique for the identified entity and corresponding sensor system. For example, where the entity identifier corresponds to a merchant, the session identifier may be unique for a particular merchant.

In some embodiments, a random value may be used as the session identifier. The random value may be generated using, for example, a pseudorandom number generator (PRNG), or a hardware random number generator (HRNG). The random value may be unique among the session identifiers that are generated for a particular merchant and/or sensor system. Since, searching for the session identifier may be performed using sub-linear time lookup.

The server may establish an association of the session identifier to an identifier corresponding to or associated with the authenticated entity and/or an account of the authenticated entity. In some cases, the session identifier is linked or mapped to the authenticated entity identifier and/or account identifier corresponding to the authenticated entity. This operation may involve adding the session identifier to a record or profile corresponding to the authenticated entity and/or account.

Various techniques and data structures may be implemented to manage the session identifiers associated with the process and establish an association between the session identifier and the authenticated entity or account identifier. In some embodiments, an association is implemented using a table or two-dimensional array, where one column contains the session identifier and the other column the corresponding authenticated entity or account identifier. Since a linear search may be inefficient for a large number of tokens, the table may be indexed by session identifier.

The computer system may receive a reply from the server that includes the generated session identifier.

In operation 410, the computer system embeds the session identifier in a machine-readable code. The machine-readable code may, in some implementations, be a quick response (QR) code. The machine-readable code may encode various data. For example, the machine-readable code may encode the session identifier. The machine-readable code may also exclude various data. For example, the machine-readable code may not encode data used to authenticate with the server. The machine-readable code may also not encode payment credentials.

The machine-readable code may encode security or verification data. For example, the machine-readable code may encode a hash. The computer system may generate the hash based on other data encoded in the machine-readable code. For example, the hash may be generated based on the session identifier. The machine-readable code may be digitally signed by the computer system and/or may encode a digital signature.

In operation 412, after preparing the machine-readable code, the computer system displays the machine-readable code at a display screen associated with or included in the computer system.

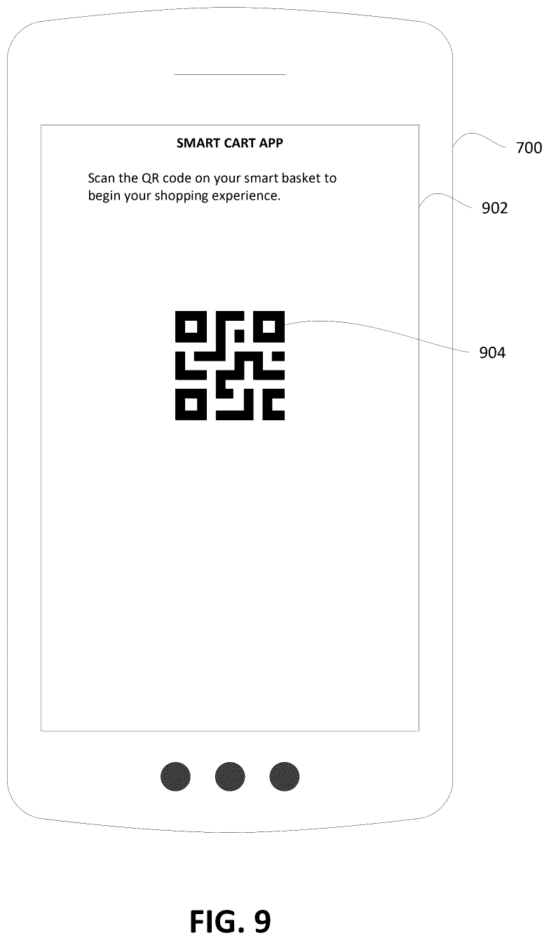

Referring briefly to FIG. 9, shown is an example machine-readable interface 902 for displaying a machine-readable code 904. The machine-readable interface 902 may be displayed at the electronic device 700 upon activation of the first option 804 of the entity identification interface 802 of FIG. 8. As shown, the machine-readable interface 902 may include a machine-readable code 904.

The operator of the computer system may use a sensor system to scan or read the machine-readable code. This operation may be performed, for example, by orienting the display screen towards a camera sensor included in the sensor system. The sensor system may, for example, be or include the sensor system 100 of FIG. 1 and the camera sensor may, for example, be or include one of the cameras 140a, 140b, receptacle contents detector 142, or code scanner 144 of the sensor system 100 of FIG. 1.

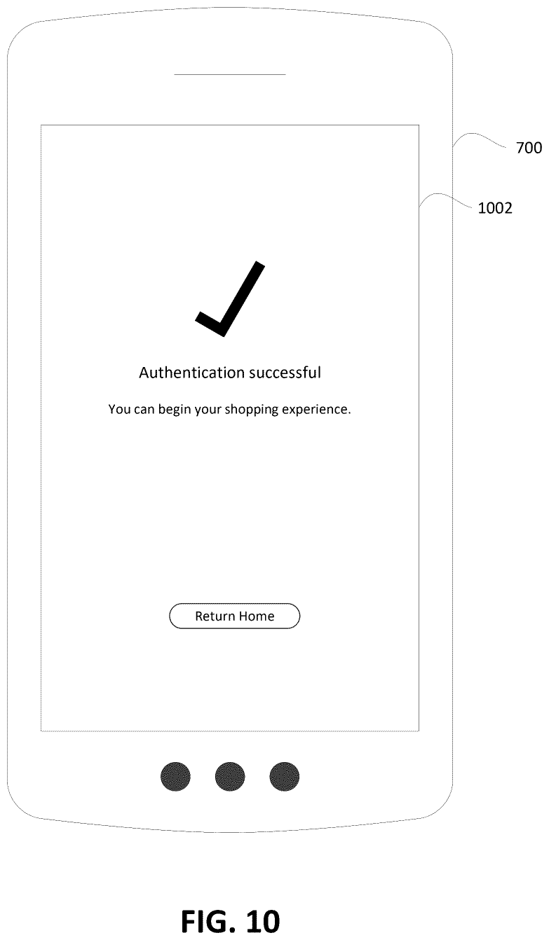

Referring back to FIG. 4, in operation 414, the computer system receives, from the server or sensor system, an indication of successful authentication with the sensor system. The indication may be in the form of a notification indicating a status message. The status message may be an authentication status message and may indicate that the user has been successfully authenticated. The computer system may then indicate that the user has been successfully authenticated. For example, referring briefly to FIG. 10, the electronic device interface 1002 may present an example notification message indicating that the use has been successfully authenticated. In some embodiments, the notification message is provided by the software application that initiated the session. In FIG. 10, an example electronic device interface 1002 is illustrated. The electronic device interface 1002 may be displayed at the electronic device 700 upon scanning of the machine-readable code 904 of FIG. 9 by a sensor. The electronic device interface 1002 may be displayed at the electronic device 700 in a software application based on the result of the processing of the machine-readable code. As shown, the electronic device interface 1002 includes example data received by the computer system.

Referring back to FIG. 4, it will be appreciated that the method 400 of FIG. 4 may be varied. In particular, persons ordinarily skilled in the art will appreciate that in some embodiments one or more operations performed by the computer system may instead be performed by the server. For example, the machine-readable code may be generated by the server instead of the computer system. The computer system may transmit a request to the server that triggers the server to generate the session identifier and/or machine-readable code and may receive a reply that includes the generated session identifier and/or machine-readable code. The machine-readable code may be digitally signed by the server.

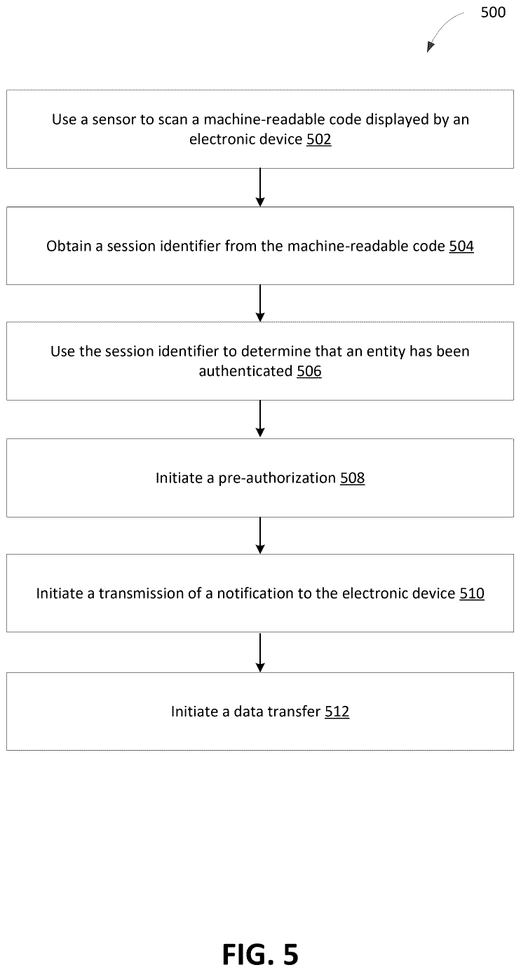

Reference will now be made to FIG. 5 which illustrates an example method 500 of initiating a pre-authorization based on sensor input. The method 500 may be implemented by one or more computer systems suitably programmed to carry out the functions described. In some embodiments, the operations may be performed by a sensor system 100 of FIG. 1 or 2, which may cooperate and communicate with an electronic device 130 of FIG. 1 or 2 and/or with a trusted system 210 of FIG. 2 to perform the method 500 or a variation thereof.

In some embodiments, the method 500 may be performed in response to displaying the machine-readable code in operation 412 of the method of FIG. 4.

In operation 502, the computer system may scan a machine-readable code displayed by an electronic device. In some embodiments, the machine-readable code may be the machine-readable code displayed in operation 412 of the method of FIG. 4. The machine-readable code may be displayed in an interface included in a software application associated with a server, which may be, for example, a trusted system.

The computer system may use a sensor to scan or read the machine-readable code. The sensor may, for example, be or include one of the cameras 140a, 140b, receptacle contents detector 142, or code scanner 144 of the sensor system 100 of FIG. 1.

The machine-readable code may be scanned or read using a sensor application that causes the computer system to continuously capture sensor data from a sensor. The captured sensor data may be monitored in real-time by the sensor application for the presence of an image representing the machine-readable code.

In operation 504, the computer system may obtain a session identifier from the machine-readable code. In some embodiments, this operation may be performed in response to scanning or detecting a machine-readable code. The machine-readable code may be decoded to obtain the session identifier embedded in the machine-readable code.

In some embodiments, the session identifier may be a one-time session identifier and may be valid for only one session with the computer system and at a premises. The session identifier may be based on an initial authentication, with a trusted system, occurring in a session between the trusted system and the electronic device.

In operation 506, the computer system may use the session identifier to determine that an entity has been authenticated. In particular, when the machine-readable code is scanned at a receptacle, the computer system associated with the receptacle may send a notification to a server associated with the software application that includes an interface that displays the machine-readable code. The notification may request confirmation that the session identifier is associated with an entity that has been authenticated with the server and/or approved, by an entity controlling the server, to, for example, shop with a merchant in an ambient commerce shopping session. The entity controlling the server may indicate, to the sensor system, that the entity has been authenticated as being associated with an account at the server.

In some embodiments, the determination that the entity has been authenticated may include using the session identifier to lookup an identifier of an authenticated entity. In some embodiments, the entity may be the entity authenticated with the server in operation 402 of the method of FIG. 4 and may be an operator of, and/or an entity in control of, an electronic device and/or software application that displays the machine-readable code.

In some embodiments, the determination may include providing, to the server, the session identifier. The server may correspond to the trusted system 210 in the operating environment of FIG. 2 and/or the server in the method of FIG. 4. The server may receive the session identifier and use the session identifier to lookup an authenticated entity identified by the session identifier. For example, the server may use the session identifier to lookup, in a table or other data structure, an authenticated entity identifier and/or account identifier corresponding to the authenticated entity. In response to receiving the session identifier, the server may provide, to the computer system, an indication that authentication has been performed by the server for an unauthenticated entity based on a session identifier. The indication may include the authenticated entity identifier. The authenticated entity identifier may be or include an account identifier corresponding to the authenticated entity.

In some embodiments, instead of sending the session identifier to the server to determine that an entity has been authenticated, the computer system may automatically receive, from the server, data including the session identifier and an identifier of the corresponding authenticated entity. The data may be automatically sent by the trusted system and received by the computer system in response to the server generating the session identifier or receiving the generated session identifier from an electronic device, or in response to the server associating the session identifier with an authenticated entity identifier. The computer system may store an association between the session identifier and authenticated entity identifier. The stored associated may subsequently be used to lookup the authenticated entity identifier to determine that an entity has been authenticated.

In operation 508, the computer system may initiate a pre-authorization. The pre-authorization may be initiated and processed without requiring a data transfer credential and/or a payment credential.

The pre-authorization may be for a defined amount at the server, which may be a transfer processing system. For example, the computer system may send a message to the transfer processing system to request a pre-authorization be applied to an account corresponding to the authenticated entity. This message may indicate a requested amount of the pre-authorization and it may be associated with or reference the session identifier. The transfer processing system may receive this message and process the pre-authorization on the account associated with the session identifier. The transfer processing system may then indicate to the receptacle or sensor system that that the pre-authorization was processed. This may allow an ambient commerce session to commence.

The pre-authorization may be initiated without performing a subsequent authentication of the entity. For example, an entity may use an electronic device to authenticate with a trusted system and the computer system may initiate the pre-authorization without performing a subsequent authentication corresponding to the pre-authorization. Thus, the entity only needs to be authenticated once with the trusted system.

In operation 510, in response to determining that the entity has been authenticated and/or in response to initiating the pre-authorization, the computer system may initiate a transmission of a notification to the electronic device indicating that the entity has successfully authenticated with the sensor system. In some embodiments, the computer system sends a request to the server to transmits the notification to the software application associated with the server and running on the electronic device.

In operation 512, the computer system may initiate a data transfer corresponding to the pre-authorization. The initiation of the data transfer may be triggered by a detection of the receptacle in a particular location of the physical premises or a detection of the receptacle within or exiting a geolocation or geofence associated with the sensor system 100. The initiation of the data transfer may include sending a request to the server to process a data transfer. In this case, the server may be a transfer processing system. The request may include a transfer amount that is less than or equal to a pre-authorized amount. The transfer processing system may process the transfer of the transfer amount from an account corresponding to the authorized entity to an account corresponding to the entity controlling the physical premises.

Notably, the server does not share credentials with the receptacle. The credentials may be, for example, data transfer credentials, which may be or include payment credentials. A data transfer may be processed by an entity controlling the physical premises without that entity obtaining the data transfer credentials. Further, the receptacle or sensor system may not need the data transfer credential in order to process a data transfer. Instead, the transfer may be processed using only the session identifier.

In some embodiments where the sensor system is an ambient commerce shopping system, a payment may be processed by a merchant without the merchant obtaining the payment credential. Further, the receptacle may not need the payment credential in order to process a payment. Instead, the payment may be processed using only the session identifier.

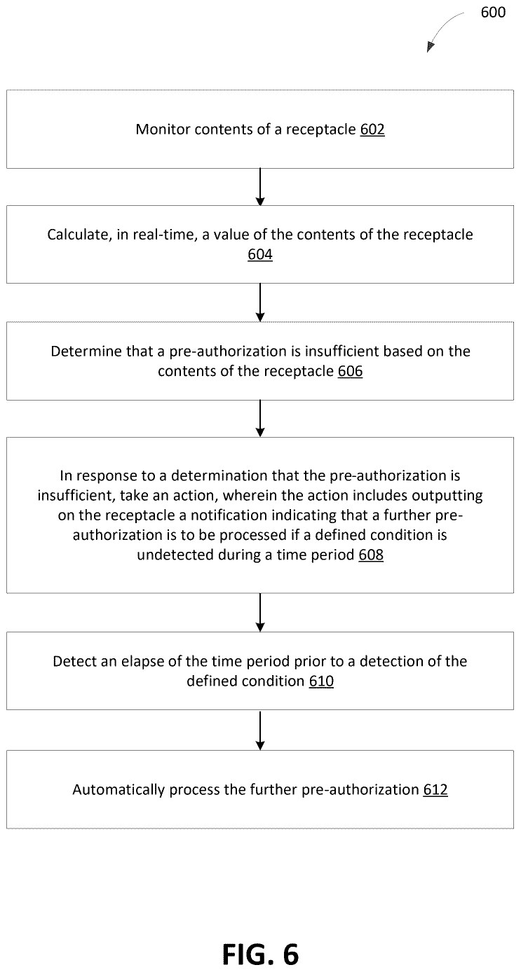

Reference will now be made to FIG. 6 which illustrates an example method 600 for processing a further pre-authorization. The method 600 may be included in an implementation of the method 500 of FIG. 5. In some embodiments, the method 600 may be performed after initiating a pre-authorization in operation 508 of the method 500 of FIG. 5. The further pre-authorization may be processed using the session identifier and without requiring a data transfer credential and/or a payment credential. The further pre-authorization may be automated.

In operation 602, the computer system may continuously monitor the contents of a receptable. The contents of the receptacle may include one or more items. An item may be, for example, a physical object and/or a product available for purchase.

The computer system may perform a computer operation in response to detecting, based on the output of one or more sensors such as a receptacle contents detector, that an item has been added to a shopping receptacle. For example, the computer system may determine an identifier of the item in the receptacle and a price of the item. The identifier may be determined based on sensor data. The price of the item may be determined using, for example, a lookup table based on the identifier.

In operation 604, the computer system may determine, based on the contents of the receptacle, an amount representing a value of the contents of the receptacle. The amount may be determined in real-time in response to an item being added to the contents of the receptacle. The amount may, in some cases, be expressed in defined units of a resource.

The amount may be calculated using, for example, a formula that takes as input one or more characteristics of the contents of the receptacle and outputs an amount. For example, the formula may use a respective price of each item in the contents of the receptacle and a respective tax rate for each item in the contents of the receptacle to calculate an amount representing a total amount representing a price of the contents of the receptacle.

In operation 606, the computer system may determine that a pre-authorization is insufficient based on the contents of the receptacle. The determination may be based on a comparison of the calculated amount with a pre-authorized amount. The pre-authorization may be determined to be insufficient if the amount representing the value of the contents of the receptacle exceeds the pre-authorized amount.

In operation 608, in response to determining that the pre-authorization is insufficient, the computer system may take one or more actions.

In some embodiments, the one or more actions may include inhibiting movement of the receptacle. For example, the wheels of a shopping cart may be locked to prevent movement, or the wheels may be inhibited to slow movement, or a lockable gate may be controlled to prevent the shopping cart from leaving an area. If, however, a further pre-authorization is processed following the action intended to inhibit the movement of the cart, the action inhibiting movement of the cart may be removed so that the cart may once again be moved freely.

In some embodiments, the one or more actions may include, in real-time, outputting on the receptacle a notification of the determination that the pre-authorization is insufficient.

The computer system may generate the notification based on the pre-authorization. The notification may provide, directly or indirectly, details of the pre-authorization and a further pre-authorization. Example details of a pre-authorization may include a pre-authorized amount and example details of a further pre-authorization may include a further pre-authorization amount and a pre-authorization policy. The pre-authorization policy may include terms and conditions for a further pre-authorization. Details of the pre-authorization policy may be provided directly by including the details in the notification, or indirectly by including a link to the details. The link may include or correspond to a uniform resource locator.

The notification may be triggered when an insufficient pre-authorization amount is detected. The notification may facilitate increasing the pre-authorization amount to avoid a shortfall.

The notification may be displayed on a display associated with the computer system and/or receptacle. In some embodiments, the display may be mounted on or included in the receptacle.

In some embodiments, an electronic device the presented the machine-readable code may also present the notification to a user of the electronic device via a user interface. The user interface may be that of a shopping application, text and/or voice message application, instant message application, or an application associated with the shopping session and/or used to initiate the shopping session. In some embodiments, the user interface may be a graphical user interface that presents the notification via pop-up, alert, or in any other suitable manner. The notification may present details of the pre-authorization policy or a link to details of the pre-authorization policy. The notification may also request consent for a further pre-authorization amount and prompt for input including an indication to accept a further pre-authorized amount. The prompt may be presented as a link, button or other actionable user interface element and may include text.

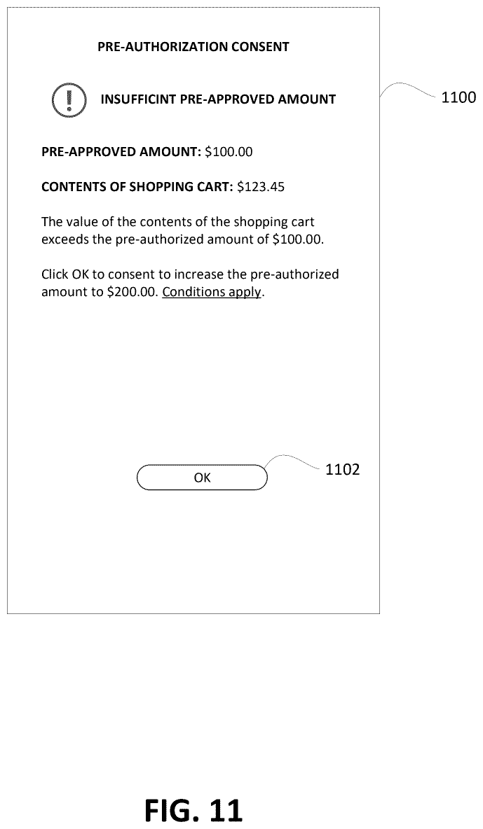

Referring briefly to FIG. 11, shown is an example notification input interface 1100 for providing consent to a further pre-authorization of a transfer. The notification input interface 1100 may be displayed on a display of the receptacle, computer system, or electronic device. The notification input interface 1100 may include a message that is provided by the notification or is generated based on the notification. In this example, the notification includes text indicating a pre-approved amount of $100.00 and a receptacle amount of $123.45.

The notification input interface 1100 also includes a selectable option 1102 that may be invoked, actuated or otherwise selected by a user. Selection of a user interface element can include a user input operation on the user interface element to provide a signal or instruction to an application executing on the computer system that a selection of the user interface element has been made by the user and/or that a particular action represented by the user interface element is to be carried out. Different forms of selection, for example, by a touch, gesture, pointing device, or voice command, will be known to those skilled in the art. In some cases, a command, action, or operation associated with the user interface element can be invoked by user input selecting or otherwise acting on a user interface element.

The selectable option 1102 may be selected to provide an indication that the user consents to a further pre-authorization and to trigger the computing system to process a further pre-authorization. The computer system may receive an instruction including an indication of actuation of the selectable option and consent to proceed with processing the further authorization.

Referring back to FIG. 6, in some embodiments, the notification may facilitate a further pre-authorization without requiring input of one or more parameters that may be required to process a pre-authorization. By way of example, the notification may include a further pre-authorization amount so that the user of the computer system may not have to input such information. In some embodiments, the notification may indicate that a further pre-authorization is to be processed if a defined condition is undetected during a time period.

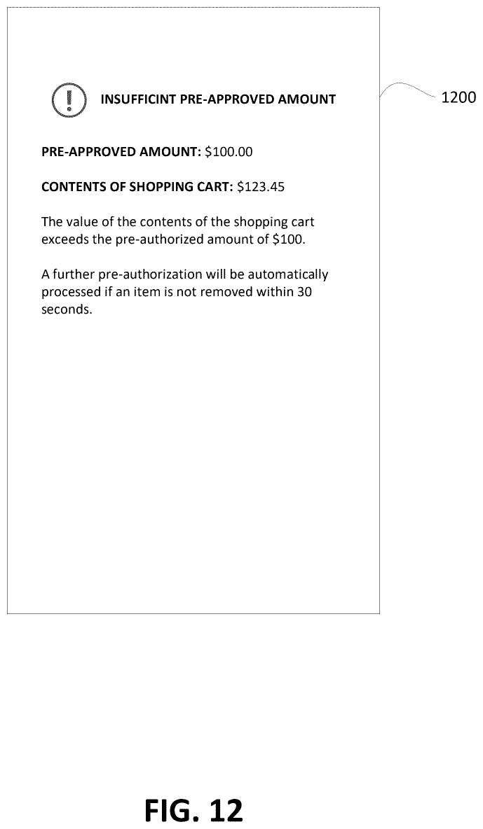

Referring briefly to FIG. 12, shown is an example notification input interface 1200 for automatically processing a further pre-authorization of a transfer. The notification input interface 1200 may be displayed on a display of the receptacle, computer system, or electronic device. The notification input interface 1200 may include a message that is provided by the notification or is generated based on the notification. In this example, the notification includes text indicating a pre-approved amount of $100.00 and a receptacle amount of $123.45. The notification may include an instruction to remove an item from the receptacle within a defined time, failing which a further pre-authorization will automatically be processed. The computer system may monitor the contents of the receptacle during the defined time and if the computer system determines that no item has been removed from the receptacle during the defined time, the computer system may automatically process a further pre-authorization of a transfer without any action taken by a user and without receiving input indicating consent to process a further pre-authorization.

Referring back to FIG. 6, in operation 610, the computer system may detect an elapse of the time period prior to a detection of the defined condition.

In operation 612, the computer system may process the further pre-authorization. The processing may occur in response to receiving the indication of consent to process a further pre-authorization. In some embodiments, the further pre-authorization may be an automated pre-authorization that may occur or be performed automatically in response to detecting the elapse of the time period prior to the detection of the defined condition. The further pre-authorization may be initiated by the computer system in a manner similar to the initial pre-authorization in operation 508 in the method 500 of FIG. 5.

The method 600 may continue in operation 510 as shown in FIG. 5. The system may perform at least some aspects of the method 500 in FIG. 5 in accordance with at least some aspects of the method 600 of FIG. 7.

It will be appreciated that it may be that some or all of the above-described operations of the various above-described example methods may be performed in orders other than those illustrated and/or may be performed concurrently without varying the overall operation of those methods.

It will also be appreciated that some or all of the above-described operations of the various above-described example methods may be triggered by, or caused by, or performed in response to, one or more of the above-described operations, and may be performed in real-time (or substantially real-time) in response to one or more of the above-described operations and/or automatically without user input.

Although many of the above examples refer to an “object” when discussing a data structure, it will be appreciated that this does not necessarily restrict the present application to implementation using object-oriented programming languages, and does not necessarily imply that the data structure is of a particular type or format. Data structures may have different names in different software paradigms.

Example embodiments of the present application may focus on a particular type of resource. However, it is understood that the present application is not limited to any such embodiments and that the embodiments described with respect to a particular type of resource generally may be extended to other types of resources.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computer system comprising:
a sensor positioned at a physical premises;
a communications module;
at least one processor coupled to the sensor and the communications module; and
a memory coupled to the at least one processor and storing instructions that, when executed by the at least one processor, are to cause the at least one processor to:
use the sensor to scan a machine-readable code;
obtain a session identifier from the machine-readable code; and
use the session identifier to:
determine that an entity has been authenticated; and
initiate a pre-authorization.

2. The computer system of claim 1, wherein the pre-authorization is for a defined amount.

3. The computer system of claim 1, wherein the pre-authorization is initiated without a transfer credential.

4. The computer system of claim 1, wherein the instructions further cause the at least one processor to:
monitor contents of a receptacle;
determine that the pre-authorization is insufficient based on the contents of the receptacle; and
in response to a determination that the pre-authorization is insufficient, take an action.

5. The computer system of claim 4, wherein the action includes outputting on the receptacle a notification indicating that a further pre-authorization is to be processed if a defined condition is undetected during a time period.

6. The computer system of claim 5, wherein the instructions further cause the at least one processor to detect an elapse of the time period prior to a detection of the defined condition and, in response, process the further pre-authorization.

7. The computer system of claim 4, wherein the action includes inhibiting movement of the receptacle.

8. The computer system of claim 7, wherein the instructions further cause the at least one processor to determine that a further pre-authorization is processed following the action inhibiting the movement of the receptacle and, in response, remove the action inhibiting the movement of the receptacle.

9. The computer system of claim 1, wherein the pre-authorization is processed using the session identifier without requiring a data transfer credential.

10. The computer system of claim 1, wherein a further automated pre-authorization is processed using the session identifier without a payment credential.

11. A computer-implemented method comprising:
using a sensor positioned at a physical premises to scan a machine-readable code;
obtaining a session identifier from the machine-readable code; and
using the session identifier to:
determine that an entity has been authenticated; and
initiate a pre-authorization.

12. The computer-implemented method of claim 11, wherein the pre-authorization is for a defined amount.

13. The computer-implemented method of claim 11, wherein the pre-authorization is initiated without a transfer credential.

14. The computer-implemented method of claim 11, further comprising:
monitoring contents of a receptacle;
determining that the pre-authorization is insufficient based on the contents of the receptacle; and
in response to determining that the pre-authorization is insufficient, taking an action.

15. The computer-implemented method of claim 14, wherein the action includes outputting on the receptacle a notification indicating that a further pre-authorization is to be processed if a defined condition is undetected during a time period.

16. The computer-implemented method of claim 15, further comprising detecting an elapse of the time period prior to a detection of the defined condition and, in response, processing the further pre-authorization.

17. The computer-implemented method of claim 14, wherein the action includes inhibiting movement of the receptacle.

18. The computer-implemented method of claim 17, further comprising determining that a further pre-authorization is processed following the action inhibiting the movement of the receptacle and, in response, removing the action inhibiting the movement of the receptacle.

19. The computer-implemented method of claim 11, wherein the pre-authorization is processed using the session identifier without requiring a data transfer credential.

20. A non-transitory computer-readable storage medium storing processor-executable instructions which, when executed by one or more processors, are to cause the one or more processors to:
use a sensor positioned at a physical premises to scan a machine-readable code;
obtain a session identifier from the machine-readable code; and
use the session identifier to:
determine that an entity has been authenticated; and
initiate a pre-authorization.
